(19) United States
(12) Patent Application Publication
(10) Pub. No.: US 2004/0027580 A1
(43) Pub. Date: Feb. 12, 2004

(54) Method for automatic determination of optical parameters of a layer stack and computer program

(76) Inventors: Hans-Artur Bosser, Breidenbach (DE); Horst Engel, Giessen (DE)

Correspondence Address: HOUSTON ELISEEVA, 4 MILITIA DRIVE, SUITE 4, LEXINGTON, MA, 02421, US

(21) Appl. No.: 10/623,059

(22) Filed: Jul. 18, 2003

(30) Foreign Application Priority Data
Jul. 19, 2002 (DE) 102 32 746.7

(51) Int. Cl. G01B 9/02

(52) U.S. Cl. 356/504

(57) ABSTRACT

The invention concerns a method for automatic determination of optical parameters of a layer stack, such as layer thicknesses, refractive indices, or absorption coefficients, by comparing an optical measured spectrum acquired from one location in the layer stack to an analysis spectrum calculated on the basis of specified optical parameter values, and optimizing the calculated analysis spectrum to the measured spectrum. It is proposed herein that the acquired measured spectrum be classified on the basis of curve shape parameters that characterize the measured spectrum and are determined therefrom, and that those curve shape parameters be compared to corresponding spectrum curve shape parameters calculated for known layer stacks in order to determine (initial) values or value ranges for the optical parameters to be identified, on the basis of which the analysis spectrum or spectra for comparison with the measured spectrum is/are calculated. The invention permits a drastic reduction in computation capacity and computation time.

### CROSS REFERENCE TO RELATED APPLICATIONS

This application claims priority of the German patent application 102 32 746.7 which is incorporated by reference herein.

### FIELD OF THE INVENTION

The invention refers to a method for automatic determination of optical parameters of a layer stack, such as layer thicknesses, refractive indices, or absorption coefficients, by comparing an optical measured spectrum acquired from one location in the layer stack to an analysis spectrum calculated on the basis of specified optical parameter values, and optimizing the calculated analysis spectrum to the measured spectrum. The invention further refers to a computer program (product) for carrying out such a method.

### BACKGROUND OF THE INVENTION

Methods of this kind play an important role especially when measuring the layer thickness of thin layers, as well as further optical parameters, such as the refractive index and extinction factor, of single- and multiple-layer systems that represent, for example, patterned wafers.

In the present description, the term “layer stack” encompasses both the layer stack in the narrower sense (sequence of individual layers, for example, SiO2, Si3N4, resist films, etc. on a substrate such as silicon or aluminum) and the combination of a layer stack and substrate.

An optical measurement device for measuring the aforesaid properties on single- and multiple-layer systems in a layer thickness range from approx. 1 nm to approx. 50 μm is known from DE 100 21 379 A1. The latter makes provision for an illumination device, for example a halogen lamp and a deuterium lamp, in order to generate a measurement light beam having a sufficiently broad wavelength range, for example between 190 nm and 800 nm. By means of a beam splitter, the measurement light beam is split into a subject light beam and a reference light beam. The measurement light beam is directed by means of a measurement objective, with an approximately perpendicular incidence, onto the measurement location of a specimen; and the beam reflected from the specimen is conveyed, together with the reference light beam, to an evaluation device. A suitable evaluation device in this context is a mirror grating spectrograph that images the wavelengths of the incoming light, in spatially separated fashion, onto a CCD detector. The latter is sensitive over the entire wavelength range, and permits a rapid readout of the measured spectra. In the aforementioned document, the reflected subject light beam and the reference light beam are conveyed via light guides to the evaluation unit. The measurement unit described can additionally contain a device that can be incoupled for visual display and monitoring.

With a measurement arrangement according to DE 100 21 379 A1, the intensity values, resulting from interferences, in the spectrum of the subject light beam reflected from the specimen are detected and evaluated in order to determine the optical layer properties. Because of ambiguities (the intensity values are calculated, depending on the layer sequence, from a number of terms that depend on the sine of the phase of the product of the respective layer thickness and the [spectrally dependent] refractive index, and on the refractive and absorption indices themselves), it is not possible, except in special cases, to calculate back analytically from the curve shape to the optical parameters. As a rule, computation-intensive fitting methods must be used.

A number of methods for evaluating the spectrum of the reflected subject light beam are known from the existing art. For example, according to European Patent EP 0 644 399 B1, the layer thickness d of a thin single layer can be determined from the number m of extreme values (maxima and minima) in the spectrum of the reflected subject light beam in the observed wavelength region from λ1 to λ2, using the known formula

$$d = 0 , 25 \times \frac{m - 1}{\frac{n1}{λ1} - \frac{n2}{λ2}} , \qquad [ ( 1 ) ]$$

n1 and n2 being the refractive indices of the thin layer at wavelengths λ1 and λ2, respectively.

With multiple-layer systems, however, a spectrum is obtained in which the interference spectra of the individual layers and of the layers with respect to one another are superimposed, so that equation (1) is no longer immediately applicable. In such a case global and local optimization methods, which are based on theoretical models with specified layer thickness ranges and optimize them in terms of the spectrum that has been determined, can be used. The method according to the aforesaid patent is based on a possible layer thickness range that depends on the total number of extremes, the wavelength of the lowest and highest extreme, and a refractive index of a layer averaged over the wavelength range. By modifying the layer thickness in the particular layer thickness range at predetermined increments for each individual layer, it is possible to identify the layer thickness combination whose calculated spectral reflection exhibits the least deviation from the measured reflection.

The method of EP 0 644 399 B1 does not represent a general method with capabilities for varying the refractive and absorption index, since these optical properties of each layer, as well as the number of layers, must be known. The layer thickness ranges always have zero as the lower limit; only the extreme positions are evaluated.

U.S. Pat. No. 4,984,894 measures the thickness of the topmost layer of a multiple-layer system on the assumption that no light is reflected from the second layer located therebelow.

The aforesaid method is restricted to the topmost layer of a specific layer sequence and to specific layer parameters, and provides only approximate results.

In U.S. Pat. No. 5,440,141 the layer thicknesses of a triple layer system of known composition are determined by using for the topmost layer the extremes method already discussed, and for the two following layers a Fourier transform method together with optimization methods for the layer thicknesses that are obtained. In the Fourier method, the reflection spectrum measured as a function of wavelength is converted into a spectrum dependent on wavelength, and is then Fourier transformed. In the case of a double layer, the absolute magnitude of the Fourier-transformed spectrum exhibits three peaks: one for each layer and one summed peak. These peaks satisfy the summed relationship, so that non-fitting peaks can be excluded. An optical thickness (nd) value can be allocated to a peak in the Fourier-transformed spectrum if the optical thicknesses are sufficiently thick in relation to the measured spectral region (at least one period in the spectral region).

The aforesaid method of U.S. Pat. No. 5,440,141 is restricted to certain layer combinations of known composition, and cannot be employed for general measurements.

Lastly, U.S. Pat. No. 5,864,633 discloses a method for optical inspection of a film stack (thin-layer stack) in which optical data and theoretical data corresponding thereto are compared, and the theoretical data are adapted by means of genetic algorithms. Each theoretical model here represents a so-called genotype (set of thin-layer parameters) that constitutes a sequenced list of genes (various layer parameters such as thickness, refractive index, extinction coefficient). A genotype thus contains the various layer parameters of all the layers. Firstly a number of genotypes is defined, and for each genotype a fit level, resulting from a comparison between the calculated theoretical data and measured data from optical inspection, is identified. Depending on the fit level, the genotypes are subjected to a genetic operation (copying, crossing, mutation). In this fashion, a new set of genotypes (new generation) can be produced from the existing set of genotypes. When the fit level of the best genotype no longer improves substantially over a number of generations, the procedure is discontinued.

Because of the large number of computation operations and the resulting computation time, this method is not suitable for industrial use in the inspection and mensuration of layered systems.

### SUMMARY OF THE INVENTION

It is therefore the object of the present invention to describe a method for automatic determination of optical material properties of a layer stack that supplies, without restrictions in terms of the number, nature, or thickness of the layers, and with as few computation operations as possible and thus in a brief time, results which permit this method to be used in particular in continuous production lines, for example in wafer fabrication.

This object is achieved by a method for automatic determination of optical parameters of a layer stack, such as layer thicknesses, refractive indices, or absorption coefficients, comprising the steps of:

acquiring an optical spectrum at one location of the layer stack;

calculating an analysis spectrum on the basis of specified optical parameter values;

comparing the acquired optical spectrum to the analysis spectrum;

optimizing the calculated analysis spectrum to the measured spectrum,

classifying the acquired measured spectrum on the basis of curve shape parameters that characterize the measured spectrum and are determined therefrom, and

comparing those curve shape parameters to corresponding spectrum curve shape parameters calculated for known layer stacks in order to determine values or value ranges for the optical parameters to be identified, on the basis of which the analysis spectrum or spectra for comparison with the measured spectrum is/are calculated.

It is a further object of the present invention to provide a computer program for automatic determination of optical material properties of a layer stack.

The above object is achieved by computer program having program code means, the computer program carries out the steps:

acquiring an optical spectrum at one location of the layer stack;

calculating an analysis spectrum on the basis of specified optical parameter values;

comparing the acquired optical spectrum to the analysis spectrum;

optimizing the calculated analysis spectrum to the measured spectrum,

classifying the acquired measured spectrum on the basis of curve shape parameters that characterize the measured spectrum and are determined therefrom, and

comparing those curve shape parameters to corresponding spectrum curve shape parameters calculated for known layer stacks in order to determine values or value ranges for the optical parameters to be identified, on the basis of which the analysis spectrum or spectra for comparison with the measured spectrum is/are calculated,

when the computer program is executed on a computer or a corresponding computation unit.

The classification according to the present invention of the acquired measured spectrum on the basis of characteristic curve shape parameters, and the subsequent comparison to corresponding curve shape parameters calculated for known layer stacks, immediately yields a first result for the optical parameters to be identified. From this, the analysis spectrum is calculated and is compared to the measured spectrum. Depending on the quality of the match, this is followed by further fitting methods as explained below. The aforesaid comparison of curve shape parameters of the classified optical spectra can also yield value ranges for the optical parameters to be determined, those ranges serving as the basis for the subsequent fitting methods.

The critical advantage of the method according to the present invention is the restriction, by means of a comparison of spectral parameters (curve shape parameters), of the possible value range for the optical parameters of a layer stack to be identified; that comparison can be performed relatively quickly by using previously calculated and pre-sorted tables. As a result, substantially reduced value ranges (as compared to existing methods) for the optical parameters to be identified are thus available for the subsequent fitting methods, so that those fitting methods can be implemented substantially more quickly.

The invention will be compared below to a conventional approximation method, as discussed in EP 0 644 399 B1 already mentioned, using the example of a triple layer. The investigation concerns the reflection spectrum in the range from 400 to 800 nm. The total thickness is assumed to be such that several extremes occur:

a) Firstly, all 401 spectral channels are evaluated, and the number of extremes is identified;

b) The layer thickness estimate in accordance with the aforesaid patent is assumed to yield upper limit values of 700 nm, 500 nm, and 400 nm;

c) For the coarse fit, the layer thickness is to be varied in the range from zero to the respective upper limit value, in increments of 10 nm;

d) The result is assumed to be 70×50×40=140,000 support points for the thickness calculation, i.e. 140,000 spectra must be calculated and compared. This is then followed by the so-called fine fit, in which the local minimum is identified exactly in a further iteration procedure. Here again, a theoretical spectrum is calculated in each iteration step.

In the example discussed, only the layer thicknesses were to be determined as optical parameters. Further parameters, such as the refractive index or absorption coefficient, are involved multiplicatively in both the coarse and fine fitting operations, so that the number of support points can rapidly amount to several million. In the example cited, typical evaluation times exceed those that make the method suitable for continuous industrial use.

The method of the aforesaid patent described by way of example has the further disadvantage that a value of zero must always be assumed as the lower limit for the layer thickness, if no further limitations are specified. If the parameter space is too severely restricted in order to shorten analysis time, incorrect evaluations can occur. If the parameter space is searched too coarsely for local minima, there is a large residual risk in terms of misinterpretation of the data and an evaluation that leads to incorrect results. In addition, interference effects can cause the determination of the number of extremes to be incorrect, an error that affects the determination of upper limit values for the layer thicknesses and propagates correspondingly.

For time-related reasons, a restriction of the parameter space for evaluation is highly desirable, especially as the number of layers increases.

According to the present invention, the acquired measured spectrum is classified by means of characteristic curve shape parameters, on the order of five to 15 such parameters generally being sufficient. The curve shape parameters of the acquired measured spectrum are then compared to the tabulated curve shape parameters of known spectra, individual values or a value range being obtained as the result for each optical parameter to be identified. Consequently, with the invention it is initially not spectra comprising 400 to 600 values, but rather table entries (having approx. 10 values), that are compared to one another, yielding a considerable reduction in computation capacity and time. The critical factor in the time savings is that calculation of a spectrum using a complex formula requires much more time (by a factor of 100,000) than comparison with the table entries.

Classification of the measured spectrum is accomplished on the basis of one or more of the following characteristic curve shape parameters: local noise of the spectrum; mean; standard deviation of the mean; number and location of extremes; a classification of the extremes, e.g. as to spectral location; intensity values or relative spacings between them; parameters of enveloping curves of the minima and maxima; averaged curve profile; beats; and possibly further parameters such as the number of peaks in the Fourier-transformed spectrum.

A restriction or filtering of the value ranges for the optical parameters to be determined is accomplished, for example, by comparing the spectral parameters to prefabricated parameter lists (tables) and, depending on the layer stack, additionally by means of an extremes method and/or a Fourier transform method. Examples of such methods are, as already mentioned, known from the existing art.

Determination of the optical parameters of the layer stack under examination can then advantageously be accomplished, on the basis of the restricted parameter space, using known coarse and fine fitting methods, for example by means of grid, interval, and/or Powell methods. Conformity between the measured and analysis spectrum is then evaluated and the “best fit” is selected.

If the method described does not lead to plausible results, the restricted parameter space can, if applicable, be expanded and the method can be run through again.

The structure of the layer stack, i.e. the composition sequence of the individual layers, is often known. If not, in an embodiment of the method according to the present invention for which protection is claimed separately, in a first step an automatic determination is made of the composition sequence of the layer stack by once again acquiring a measured spectrum and classifying it on the basis of characteristic curve shape parameters, and determining, by comparison with corresponding curve shape parameters of spectra belonging to layer stacks of known composition, one or more possible sequences of layer stack composition.

In this case as well, an analysis spectrum can furthermore be calculated on the basis of the layer stack composition results, and optimized to the measured spectrum using fitting methods. At the same time, in addition to a possible layer stack composition sequence, the layer thickness ranges, refractive index ranges, and further ranges for the relevant optical parameters can also be identified. A much larger parameter space must be searched in this case, so that it is advantageous to perform this preliminary determination of the layer stack composition and its optical parameters in the background, for example simultaneously with programming of the stage positions.

The spectral parameter space to be searched can often be restricted by specifying the possible layer/substrate combinations that will be used by a customer. The method according to the present invention then searches a priori through the most probable combinations (and associated optical parameter regions) of the available possibilities.

It is advantageous to display the results found in this preliminary determination to the customer, and to give him or her the opportunity to accept or correct the result.

The determination according to the present invention of optical parameters of a layer stack, along with possible determination of the chemical composition sequence of the layer stack, is advantageously performed by means of a computer program that is executed on a suitable computation unit. The data determined (value ranges for optical parameters, layer composition) can be displayed in the usual manner on a monitor. The customer can furthermore be offered the capability of influencing the displayed data. The computer program can be stored on suitable data media such as EEPROMs or flash memories, but also on CD-ROMs, diskettes, or hard drives. A transfer of the computer program via a communication medium (such as the Internet) to the customer (user) is also possible.

### BRIEF DESCRIPTION OF THE DRAWINGS

An exemplary embodiment of the invention and its advantages will be explained in more detail below with reference to the attached Figures, in which:

FIG. 1 shows two measured spectra of a double layer (FIG. 1a) and a single layer (FIG. 1b) on a substrate;

FIG. 2 shows the “Number of Extremes” curve shape parameter plotted against the optical thickness of a calculated parameter list for the aforesaid double layer;

FIG. 3 shows the spectrum Mean as the curve shape parameter plotted against the optical thickness of a parameter list calculated for the aforesaid double layer;

FIG. 4 shows the wavelength value of the maximum closest to the long-wave end of the measured spectrum as the curve shape parameter of the calculated spectrum, plotted against the optical thickness of the parameter list calculated for the aforesaid double layer;

FIG. 5 shows the Maximum Value as the curve shape parameter plotted against the optical thickness of the parameter list calculated for the aforesaid double layer;

FIG. 6 shows theoretical spectra of similar appearance.

### DETAILED DESCRIPTION OF THE INVENTION

The invention will be explained below with reference to the simple example of a double layer on a substrate, but is by no means limited to that specific case. The example makes use of a Si3N4-SiO2-Si combination (Si as substrate). For the method according to the present invention discussed below, the composition sequence of the layer stack is therefore known in this case.

The table below represents one example of a prefabricated calculated parameter list for the aforesaid double layer, the curve shape parameters below having been derived from the relevant calculated analysis spectra for specified thickness values D1 (thickness of Si3N4 layer) and D2 (thickness of SiO2 layer) and for the total optical thickness resulting therefrom:

D1 Specified thickness of first layer

D2 Specified thickness of second layer

Opt.Thick Optical thickness, calculated from the sum of the products of the average refractive index and the thickness in the wavelength range from 200 nm to 800 nm, i.e. optical thickness=[n1(λ)]D1+[n2(λ)]D2

NoE Number of extremes

Mean Mean of the calculated spectrum

Sigma Standard deviation of the mean of the calculated spectrum

Min Intensity value of the minimum in the wavelength range

Max Intensity value of the maximum in the wavelength range

WL-MaxEX Wavelength at which the last maximum occurs, beginning at the smallest wavelength (in nm)

MDEx Mean distance of the extremes when more than one extreme is present (in nm)

Further useful curve shape parameters, especially for thicker layers, would be the values deriving from a fast Fourier transform, such as the locations of the individual peaks and the summed peak. A search could also be made for the occurrence of beats, or for the location and intensity of the extremes that occur.

The curve shape parameter list available to the evaluation software as a lookup table is reproduced below.

TABLE 1
Si3N4SiO2Si

| | | Output | | | | | | | |
|---|---|---|---|---|---|---|---|---|---|
| Input | | Opt. | | | | | | | |
| D1 | D2 | Thick | NoE | Mean | Sigma | Min | Max | Wl-MaxEX | MDEx |
| 0 | 0 | 0 | 0 | 1.000 | 0.000 | 1.000 | 1.000 | 0 | 0 |
| 0 | 20 | 30 | 0 | 0.909 | 0.071 | 0.663 | 0.971 | 0 | 0 |
| 20 | 0 | 43 | 1 | 0.752 | 0.192 | 0.264 | 0.933 | 245 | 0 |
| 0 | 40 | 60 | 1 | 0.753 | 0.091 | 0.559 | 0.892 | 315 | 0 |
| 20 | 20 | 73 | 1 | 0.571 | 0.255 | 0.236 | 1.182 | 393 | 0 |
| 40 | 0 | 86 | 2 | 0.514 | 0.262 | 0.116 | 1.066 | 383 | 147 |
| 0 | 60 | 89 | 1 | 0.628 | 0.167 | 0.417 | 1.042 | 421 | 0 |
| 20 | 40 | 103 | 2 | 0.516 | 0.370 | 0.131 | 1.273 | 488 | 251 |
| 40 | 20 | 116 | 2 | 0.431 | 0.401 | 0.015 | 1.191 | 510 | 263 |
| 0 | 80 | 119 | 2 | 0.552 | 0.236 | 0.300 | 1.017 | 499 | 241 |
| 60 | 0 | 130 | 3 | 0.357 | 0.323 | 0.001 | 1.021 | 495 | 138 |
| 20 | 60 | 133 | 2 | 0.531 | 0.409 | 0.051 | 1.241 | 611 | 297 |
| 40 | 40 | 146 | 2 | 0.538 | 0.483 | 0.027 | 1.323 | 322 | 104 |
| 0 | 100 | 149 | 3 | 0.531 | 0.272 | 0.255 | 1.006 | 602 | 190 |
| 60 | 20 | 159 | 2 | 0.489 | 0.441 | 0.000 | 1.189 | 335 | 89 |
| 20 | 80 | 162 | 2 | 0.629 | 0.408 | 0.143 | 1.221 | 343 | 96 |
| 80 | 0 | 173 | 4 | 0.404 | 0.370 | 0.002 | 1.012 | 646 | 141 |
| 40 | 60 | 176 | 2 | 0.730 | 0.479 | 0.046 | 1.370 | 400 | 154 |
| 0 | 120 | 179 | 2 | 0.583 | 0.290 | 0.234 | 1.034 | 362 | 110 |
| 60 | 40 | 189 | 3 | 0.758 | 0.456 | 0.010 | 1.337 | 408 | 91 |
| 20 | 100 | 192 | 2 | 0.767 | 0.371 | 0.169 | 1.247 | 419 | 135 |
| 80 | 20 | 203 | 3 | 0.645 | 0.401 | 0.006 | 1.233 | 416 | 90 |
| 40 | 80 | 206 | 3 | 0.915 | 0.408 | 0.178 | 1.471 | 440 | 103 |
| 0 | 140 | 208 | 3 | 0.663 | 0.273 | 0.226 | 1.032 | 413 | 94 |
| 100 | 0 | 216 | 4 | 0.509 | 0.362 | 0.006 | 1.053 | 416 | 67 |
| 60 | 60 | 219 | 3 | 0.966 | 0.399 | 0.001 | 1.502 | 455 | 107 |
| 20 | 120 | 222 | 3 | 0.854 | 0.325 | 0.203 | 1.268 | 470 | 116 |
| 80 | 40 | 232 | 4 | 0.911 | 0.356 | 0.069 | 1.361 | 473 | 87 |
| 40 | 100 | 235 | 3 | 1.016 | 0.388 | 0.100 | 1.498 | 486 | 120 |
| 0 | 160 | 238 | 3 | 0.727 | 0.224 | 0.292 | 1.022 | 470 | 109 |
| 100 | 20 | 246 | 4 | 0.762 | 0.303 | 0.203 | 1.159 | 491 | 88 |
| 60 | 80 | 249 | 4 | 1.089 | 0.394 | 0.195 | 1.588 | 503 | 91 |
| 20 | 140 | 252 | 4 | 0.890 | 0.285 | 0.116 | 1.220 | 528 | 102 |
| 120 | 0 | 259 | 5 | 0.636 | 0.289 | 0.104 | 1.025 | 492 | 69 |
| 80 | 60 | 262 | 4 | 1.089 | 0.334 | 0.109 | 1.518 | 524 | 98 |
| 40 | 120 | 265 | 4 | 1.069 | 0.364 | 0.119 | 1.489 | 544 | 106 |
| 0 | 180 | 268 | 4 | 0.778 | 0.175 | 0.440 | 1.008 | 527 | 98 |
| 100 | 40 | 276 | 5 | 0.996 | 0.270 | 0.396 | 1.327 | 549 | 83 |
| 60 | 100 | 278 | 4 | 1.163 | 0.397 | 0.196 | 1.625 | 556 | 103 |
| 20 | 160 | 281 | 4 | 0.913 | 0.297 | 0.186 | 1.231 | 586 | 114 |
| 120 | 20 | 289 | 5 | 0.832 | 0.279 | 0.132 | 1.195 | 569 | 85 |
| 80 | 80 | 292 | 5 | 1.171 | 0.379 | 0.225 | 1.616 | 575 | 87 |
| 40 | 140 | 295 | 5 | 1.062 | 0.395 | 0.050 | 1.461 | 601 | 96 |
| 0 | 200 | 298 | 4 | 0.811 | 0.174 | 0.408 | 1.039 | 584 | 111 |
| 140 | 0 | 302 | 6 | 0.706 | 0.278 | 0.008 | 1.018 | 569 | 71 |
| 100 | 60 | 305 | 5 | 1.106 | 0.345 | 0.017 | 1.487 | 601 | 93 |
| 60 | 120 | 308 | 5 | 1.160 | 0.437 | 0.075 | 1.626 | 612 | 95 |
| 20 | 180 | 311 | 5 | 0.910 | 0.323 | 0.145 | 1.247 | 647 | 104 |
| 120 | 40 | 319 | 5 | 0.980 | 0.334 | 0.004 | 1.327 | 630 | 98 |
| 80 | 100 | 322 | 5 | 1.166 | 0.461 | 0.033 | 1.667 | 629 | 98 |
| 40 | 160 | 325 | 5 | 1.019 | 0.425 | 0.022 | 1.428 | 664 | 108 |
| 0 | 220 | 328 | 5 | 0.812 | 0.198 | 0.345 | 1.031 | 641 | 102 |
| 140 | 20 | 332 | 6 | 0.811 | 0.332 | 0.047 | 1.201 | 650 | 86 |
| 100 | 80 | 335 | 6 | 1.124 | 0.424 | 0.088 | 1.597 | 654 | 87 |
| 60 | 140 | 338 | 6 | 1.088 | 0.487 | 0.016 | 1.612 | 673 | 91 |
| 20 | 200 | 341 | 5 | 0.857 | 0.348 | 0.066 | 1.264 | 474 | 65 |
| 160 | 0 | 346 | 7 | 0.702 | 0.312 | 0.009 | 1.040 | 647 | 72 |
| 120 | 60 | 349 | 6 | 1.044 | 0.379 | 0.027 | 1.441 | 684 | 92 |
| 80 | 120 | 351 | 5 | 1.102 | 0.518 | 0.095 | 1.689 | 435 | 54 |
| 40 | 180 | 354 | 5 | 0.956 | 0.435 | 0.016 | 1.394 | 479 | 66 |
| 0 | 240 | 357 | 5 | 0.786 | 0.221 | 0.309 | 1.025 | 473 | 64 |
| 140 | 40 | 362 | 5 | 0.914 | 0.362 | 0.121 | 1.284 | 484 | 64 |
| 100 | 100 | 365 | 5 | 1.085 | 0.479 | 0.151 | 1.666 | 456 | 57 |
| 60 | 160 | 368 | 5 | 1.016 | 0.480 | 0.003 | 1.585 | 475 | 61 |
| 20 | 220 | 371 | 5 | 0.807 | 0.355 | 0.129 | 1.225 | 514 | 72 |
| 160 | 20 | 375 | 6 | 0.758 | 0.350 | 0.019 | 1.151 | 495 | 54 |
| 120 | 80 | 378 | 6 | 1.036 | 0.424 | 0.159 | 1.557 | 487 | 53 |
| 80 | 140 | 381 | 6 | 1.022 | 0.519 | 0.029 | 1.689 | 473 | 51 |
| 40 | 200 | 384 | 5 | 0.889 | 0.438 | 0.016 | 1.396 | 522 | 73 |
| 0 | 260 | 387 | 5 | 0.756 | 0.236 | 0.286 | 1.043 | 510 | 69 |
| 180 | 0 | 389 | 7 | 0.655 | 0.340 | 0.001 | 1.026 | 491 | 47 |
| 140 | 60 | 392 | 6 | 0.953 | 0.395 | 0.053 | 1.403 | 517 | 59 |
| 100 | 120 | 395 | 6 | 1.014 | 0.503 | 0.151 | 1.703 | 485 | 53 |
| 60 | 180 | 398 | 6 | 0.949 | 0.463 | 0.000 | 1.553 | 518 | 60 |
| 20 | 240 | 401 | 5 | 0.778 | 0.359 | 0.129 | 1.246 | 553 | 77 |
| 160 | 40 | 405 | 6 | 0.841 | 0.384 | 0.018 | 1.342 | 538 | 62 |
| 120 | 100 | 408 | 6 | 0.994 | 0.452 | 0.002 | 1.638 | 514 | 56 |
| 80 | 160 | 411 | 6 | 0.949 | 0.491 | 0.006 | 1.675 | 514 | 57 |
| 40 | 220 | 414 | 6 | 0.836 | 0.440 | 0.017 | 1.455 | 564 | 68 |
| 0 | 280 | 417 | 6 | 0.730 | 0.238 | 0.270 | 1.035 | 548 | 65 |
| 180 | 20 | 419 | 7 | 0.703 | 0.366 | 0.007 | 1.169 | 548 | 55 |
| 140 | 80 | 422 | 7 | 0.944 | 0.417 | 0.016 | 1.507 | 546 | 55 |
| 100 | 140 | 424 | 7 | 0.925 | 0.499 | 0.009 | 1.716 | 519 | 51 |
| 60 | 200 | 427 | 7 | 0.879 | 0.458 | 0.000 | 1.487 | 561 | 58 |
| 20 | 260 | 430 | 6 | 0.751 | 0.362 | 0.044 | 1.263 | 593 | 72 |
| 200 | 0 | 432 | 7 | 0.614 | 0.336 | 0.000 | 1.017 | 543 | 53 |
| 160 | 60 | 435 | 7 | 0.884 | 0.403 | 0.001 | 1.482 | 574 | 59 |
| 120 | 120 | 438 | 7 | 0.931 | 0.449 | 0.017 | 1.674 | 541 | 54 |
| 80 | 180 | 441 | 7 | 0.886 | 0.454 | 0.000 | 1.614 | 556 | 57 |
| 40 | 240 | 444 | 7 | 0.803 | 0.447 | 0.021 | 1.486 | 605 | 66 |
| 0 | 300 | 447 | 6 | 0.702 | 0.235 | 0.257 | 1.031 | 586 | 70 |
| 180 | 40 | 448 | 7 | 0.790 | 0.400 | 0.046 | 1.363 | 593 | 62 |
| 140 | 100 | 451 | 7 | 0.916 | 0.406 | 0.141 | 1.549 | 573 | 58 |
| 100 | 160 | 454 | 7 | 0.855 | 0.456 | 0.027 | 1.665 | 556 | 55 |
| 60 | 220 | 457 | 7 | 0.834 | 0.451 | 0.000 | 1.527 | 605 | 64 |
| 20 | 280 | 460 | 7 | 0.724 | 0.369 | 0.098 | 1.263 | 633 | 69 |
| 200 | 20 | 462 | 8 | 0.658 | 0.366 | 0.002 | 1.202 | 600 | 55 |
| 160 | 80 | 465 | 8 | 0.886 | 0.401 | 0.098 | 1.537 | 604 | 55 |
| 120 | 140 | 468 | 8 | 0.847 | 0.430 | 0.045 | 1.633 | 572 | 51 |
| 80 | 200 | 471 | 7 | 0.830 | 0.424 | 0.001 | 1.465 | 599 | 63 |
| 40 | 260 | 474 | 7 | 0.784 | 0.462 | 0.025 | 1.498 | 647 | 71 |
| 220 | 0 | 475 | 8 | 0.563 | 0.327 | 0.001 | 1.034 | 595 | 53 |
| 180 | 60 | 478 | 8 | 0.835 | 0.423 | 0.060 | 1.515 | 630 | 59 |
| 140 | 120 | 481 | 8 | 0.856 | 0.383 | 0.106 | 1.511 | 600 | 55 |
| 100 | 180 | 484 | 8 | 0.795 | 0.408 | 0.006 | 1.529 | 596 | 54 |
| 60 | 240 | 487 | 7 | 0.808 | 0.466 | 0.000 | 1.572 | 648 | 69 |
| 20 | 300 | 490 | 7 | 0.707 | 0.383 | 0.135 | 1.239 | 672 | 74 |
| 200 | 40 | 492 | 8 | 0.741 | 0.422 | 0.028 | 1.358 | 648 | 61 |
| 160 | 100 | 495 | 8 | 0.852 | 0.395 | 0.026 | 1.517 | 632 | 58 |
| 120 | 160 | 497 | 8 | 0.759 | 0.407 | 0.033 | 1.507 | 605 | 54 |
| 80 | 220 | 500 | 8 | 0.781 | 0.428 | 0.002 | 1.466 | 643 | 60 |
| 40 | 280 | 503 | 8 | 0.769 | 0.483 | 0.030 | 1.498 | 689 | 67 |
| 220 | 20 | 505 | 9 | 0.608 | 0.383 | 0.000 | 1.189 | 653 | 55 |
| 180 | 80 | 508 | 9 | 0.835 | 0.436 | 0.007 | 1.585 | 663 | 56 |
| 140 | 140 | 511 | 9 | 0.763 | 0.378 | 0.003 | 1.390 | 628 | 52 |
| 100 | 200 | 514 | 9 | 0.734 | 0.389 | 0.000 | 1.290 | 638 | 54 |
| 60 | 260 | 517 | 8 | 0.794 | 0.500 | 0.000 | 1.602 | 691 | 67 |
| 240 | 0 | 518 | 9 | 0.517 | 0.335 | 0.002 | 1.026 | 647 | 53 |
| 200 | 60 | 521 | 9 | 0.801 | 0.457 | 0.014 | 1.521 | 687 | 59 |
| 160 | 120 | 524 | 9 | 0.794 | 0.390 | 0.005 | 1.437 | 660 | 56 |
| 120 | 180 | 527 | 9 | 0.695 | 0.384 | 0.006 | 1.331 | 641 | 54 |
| 80 | 240 | 530 | 8 | 0.762 | 0.464 | 0.003 | 1.534 | 686 | 65 |
| 40 | 300 | 533 | 8 | 0.773 | 0.496 | 0.026 | 1.492 | 730 | 72 |
| 220 | 40 | 535 | 9 | 0.722 | 0.444 | 0.010 | 1.343 | 702 | 60 |
| 180 | 100 | 538 | 9 | 0.821 | 0.440 | 0.035 | 1.588 | 692 | 59 |
| 140 | 160 | 541 | 9 | 0.694 | 0.364 | 0.036 | 1.284 | 658 | 55 |
| 100 | 220 | 544 | 9 | 0.709 | 0.400 | 0.001 | 1.317 | 681 | 58 |
| 60 | 280 | 546 | 9 | 0.808 | 0.524 | 0.001 | 1.620 | 734 | 65 |
| 240 | 20 | 548 | 10 | 0.599 | 0.399 | 0.000 | 1.160 | 706 | 54 |
| 200 | 80 | 551 | 10 | 0.834 | 0.472 | 0.042 | 1.609 | 721 | 56 |
| 160 | 140 | 554 | 10 | 0.739 | 0.373 | 0.016 | 1.322 | 687 | 53 |
| 120 | 200 | 557 | 9 | 0.669 | 0.381 | 0.009 | 1.290 | 680 | 58 |
| 80 | 260 | 560 | 9 | 0.789 | 0.499 | 0.003 | 1.587 | 730 | 64 |
| 260 | 0 | 562 | 10 | 0.503 | 0.351 | 0.004 | 1.018 | 699 | 53 |
| 220 | 60 | 565 | 10 | 0.822 | 0.473 | 0.013 | 1.513 | 743 | 58 |
| 180 | 120 | 567 | 10 | 0.801 | 0.437 | 0.076 | 1.535 | 720 | 56 |
| 140 | 180 | 570 | 10 | 0.660 | 0.375 | 0.061 | 1.341 | 691 | 53 |
| 100 | 240 | 573 | 9 | 0.736 | 0.435 | 0.003 | 1.407 | 724 | 62 |
| 60 | 300 | 576 | 8 | 0.862 | 0.514 | 0.002 | 1.628 | 568 | 49 |
| 240 | 40 | 578 | 9 | 0.756 | 0.447 | 0.010 | 1.323 | 562 | 43 |
| 200 | 100 | 581 | 10 | 0.855 | 0.474 | 0.066 | 1.634 | 751 | 59 |
| 160 | 160 | 584 | 10 | 0.704 | 0.374 | 0.007 | 1.229 | 715 | 55 |
| 120 | 220 | 587 | 10 | 0.683 | 0.402 | 0.001 | 1.299 | 721 | 56 |
| 80 | 280 | 590 | 9 | 0.848 | 0.502 | 0.003 | 1.626 | 571 | 45 |
| 260 | 20 | 591 | 10 | 0.632 | 0.401 | 0.000 | 1.191 | 571 | 40 |
| 220 | 80 | 594 | 10 | 0.888 | 0.477 | 0.025 | 1.616 | 572 | 40 |
| 180 | 140 | 597 | 11 | 0.776 | 0.426 | 0.019 | 1.440 | 747 | 54 |
| 140 | 200 | 600 | 10 | 0.653 | 0.406 | 0.035 | 1.420 | 727 | 56 |
| 100 | 260 | 603 | 9 | 0.796 | 0.454 | 0.005 | 1.484 | 577 | 45 |
| 280 | 0 | 605 | 11 | 0.530 | 0.358 | 0.004 | 1.031 | 752 | 53 |
| 240 | 60 | 608 | 10 | 0.890 | 0.448 | 0.043 | 1.497 | 588 | 41 |
| 200 | 120 | 611 | 10 | 0.864 | 0.462 | 0.036 | 1.604 | 580 | 41 |
| 160 | 180 | 614 | 11 | 0.695 | 0.394 | 0.012 | 1.360 | 746 | 54 |
| 120 | 240 | 617 | 10 | 0.737 | 0.415 | 0.000 | 1.273 | 763 | 60 |
| 80 | 300 | 619 | 9 | 0.916 | 0.477 | 0.028 | 1.654 | 600 | 47 |
| 260 | 40 | 621 | 10 | 0.821 | 0.411 | 0.007 | 1.344 | 602 | 43 |
| 220 | 100 | 624 | 10 | 0.934 | 0.461 | 0.000 | 1.658 | 595 | 42 |
| 180 | 160 | 627 | 10 | 0.770 | 0.401 | 0.002 | 1.324 | 597 | 42 |
| 140 | 220 | 630 | 10 | 0.689 | 0.416 | 0.014 | 1.447 | 603 | 43 |
| 100 | 280 | 633 | 10 | 0.866 | 0.440 | 0.011 | 1.546 | 605 | 43 |
| 280 | 20 | 635 | 11 | 0.686 | 0.370 | 0.010 | 1.202 | 610 | 40 |
| 240 | 80 | 638 | 11 | 0.973 | 0.434 | 0.011 | 1.610 | 612 | 40 |
| 200 | 140 | 640 | 11 | 0.859 | 0.436 | 0.003 | 1.531 | 607 | 40 |
| 160 | 200 | 643 | 10 | 0.709 | 0.407 | 0.002 | 1.460 | 616 | 44 |
| 120 | 260 | 646 | 10 | 0.814 | 0.392 | 0.006 | 1.330 | 615 | 44 |
| 300 | 0 | 648 | 11 | 0.577 | 0.339 | 0.001 | 1.025 | 608 | 39 |
| 260 | 60 | 651 | 11 | 0.960 | 0.400 | 0.004 | 1.475 | 629 | 41 |
| 220 | 120 | 654 | 11 | 0.948 | 0.445 | 0.011 | 1.649 | 621 | 41 |
| 180 | 180 | 657 | 11 | 0.778 | 0.381 | 0.001 | 1.297 | 626 | 42 |
| 140 | 240 | 660 | 10 | 0.760 | 0.387 | 0.006 | 1.433 | 629 | 45 |
| 100 | 300 | 663 | 10 | 0.927 | 0.426 | 0.111 | 1.596 | 635 | 46 |
| 280 | 40 | 664 | 11 | 0.871 | 0.371 | 0.049 | 1.361 | 643 | 43 |
| 240 | 100 | 667 | 11 | 1.008 | 0.439 | 0.087 | 1.669 | 637 | 42 |
| 200 | 160 | 670 | 11 | 0.850 | 0.403 | 0.004 | 1.432 | 636 | 42 |
| 160 | 220 | 673 | 11 | 0.741 | 0.399 | 0.034 | 1.519 | 644 | 43 |
| 120 | 280 | 676 | 11 | 0.877 | 0.373 | 0.035 | 1.411 | 644 | 43 |
| 300 | 20 | 678 | 12 | 0.724 | 0.345 | 0.011 | 1.189 | 650 | 40 |
| 260 | 80 | 681 | 12 | 1.023 | 0.420 | 0.051 | 1.599 | 653 | 40 |
| 220 | 140 | 684 | 12 | 0.926 | 0.448 | 0.022 | 1.602 | 647 | 40 |
| 180 | 200 | 687 | 11 | 0.784 | 0.380 | 0.004 | 1.426 | 655 | 44 |
| 140 | 260 | 690 | 11 | 0.826 | 0.352 | 0.062 | 1.383 | 657 | 44 |
| 280 | 60 | 694 | 12 | 0.989 | 0.391 | 0.035 | 1.504 | 670 | 42 |
| 240 | 120 | 697 | 12 | 0.998 | 0.460 | 0.077 | 1.680 | 661 | 41 |
| 200 | 180 | 700 | 12 | 0.843 | 0.376 | 0.000 | 1.331 | 664 | 41 |
| 160 | 240 | 703 | 11 | 0.786 | 0.383 | 0.024 | 1.538 | 671 | 45 |
| 120 | 300 | 706 | 11 | 0.911 | 0.393 | 0.002 | 1.481 | 672 | 45 |
| 300 | 40 | 708 | 12 | 0.888 | 0.368 | 0.036 | 1.363 | 683 | 43 |
| 260 | 100 | 711 | 12 | 1.035 | 0.454 | 0.015 | 1.671 | 678 | 42 |
| 220 | 160 | 713 | 12 | 0.896 | 0.437 | 0.004 | 1.522 | 674 | 42 |
| 180 | 220 | 716 | 12 | 0.794 | 0.389 | 0.009 | 1.519 | 684 | 43 |
| 140 | 280 | 719 | 12 | 0.864 | 0.348 | 0.005 | 1.309 | 684 | 43 |
| 280 | 80 | 724 | 13 | 1.031 | 0.434 | 0.004 | 1.582 | 695 | 40 |
| 240 | 140 | 727 | 12 | 0.958 | 0.476 | 0.017 | 1.652 | 686 | 43 |
| 200 | 200 | 730 | 12 | 0.835 | 0.371 | 0.000 | 1.339 | 694 | 44 |
| 160 | 260 | 733 | 12 | 0.830 | 0.370 | 0.003 | 1.522 | 699 | 44 |
| 300 | 60 | 737 | 13 | 0.985 | 0.405 | 0.019 | 1.517 | 711 | 41 |
| 260 | 120 | 740 | 13 | 1.008 | 0.482 | 0.009 | 1.697 | 702 | 41 |
| 220 | 180 | 743 | 12 | 0.874 | 0.413 | 0.000 | 1.423 | 703 | 44 |
| 180 | 240 | 746 | 12 | 0.812 | 0.401 | 0.023 | 1.574 | 713 | 45 |
| 140 | 300 | 749 | 12 | 0.882 | 0.368 | 0.034 | 1.335 | 711 | 45 |
| 280 | 100 | 754 | 13 | 1.025 | 0.470 | 0.018 | 1.664 | 718 | 42 |
| 240 | 160 | 757 | 13 | 0.910 | 0.474 | 0.027 | 1.592 | 713 | 42 |
| 200 | 220 | 760 | 13 | 0.827 | 0.388 | 0.001 | 1.462 | 723 | 42 |
| 160 | 280 | 762 | 13 | 0.855 | 0.366 | 0.002 | 1.477 | 725 | 43 |
| 300 | 80 | 767 | 14 | 1.008 | 0.447 | 0.018 | 1.585 | 736 | 40 |
| 260 | 140 | 770 | 13 | 0.952 | 0.495 | 0.002 | 1.686 | 727 | 42 |
| 220 | 200 | 773 | 13 | 0.847 | 0.401 | 0.001 | 1.351 | 732 | 43 |
| 180 | 260 | 776 | 13 | 0.827 | 0.413 | 0.064 | 1.593 | 740 | 44 |
| 280 | 120 | 784 | 13 | 0.984 | 0.489 | 0.046 | 1.703 | 587 | 31 |
| 240 | 180 | 786 | 13 | 0.869 | 0.453 | 0.004 | 1.508 | 741 | 44 |
| 200 | 240 | 789 | 12 | 0.821 | 0.413 | 0.008 | 1.551 | 620 | 37 |
| 160 | 300 | 792 | 12 | 0.856 | 0.373 | 0.009 | 1.412 | 617 | 36 |
| 300 | 100 | 797 | 13 | 0.991 | 0.471 | 0.048 | 1.651 | 604 | 33 |
| 260 | 160 | 800 | 13 | 0.892 | 0.485 | 0.014 | 1.643 | 591 | 31 |
| 220 | 220 | 803 | 13 | 0.824 | 0.403 | 0.001 | 1.366 | 618 | 34 |
| 180 | 280 | 806 | 13 | 0.831 | 0.418 | 0.022 | 1.585 | 636 | 35 |
| 280 | 140 | 813 | 13 | 0.921 | 0.485 | 0.016 | 1.706 | 603 | 32 |
| 240 | 200 | 816 | 13 | 0.833 | 0.427 | 0.000 | 1.432 | 614 | 33 |
| 200 | 260 | 819 | 13 | 0.817 | 0.434 | 0.025 | 1.607 | 646 | 36 |
| 300 | 120 | 827 | 13 | 0.946 | 0.472 | 0.029 | 1.701 | 620 | 34 |
| 260 | 180 | 830 | 13 | 0.842 | 0.460 | 0.006 | 1.576 | 614 | 33 |
| 220 | 240 | 833 | 13 | 0.812 | 0.412 | 0.000 | 1.484 | 647 | 36 |
| 180 | 300 | 835 | 13 | 0.828 | 0.412 | 0.011 | 1.550 | 657 | 37 |
| 280 | 160 | 843 | 14 | 0.855 | 0.464 | 0.004 | 1.680 | 622 | 31 |
| 240 | 220 | 846 | 14 | 0.804 | 0.411 | 0.001 | 1.447 | 644 | 33 |
| 200 | 280 | 849 | 14 | 0.808 | 0.449 | 0.009 | 1.632 | 670 | 35 |
| 300 | 140 | 856 | 14 | 0.877 | 0.461 | 0.007 | 1.716 | 636 | 32 |
| 260 | 200 | 859 | 14 | 0.799 | 0.433 | 0.001 | 1.489 | 641 | 33 |
| 220 | 260 | 862 | 14 | 0.803 | 0.436 | 0.004 | 1.571 | 675 | 36 |
| 280 | 180 | 873 | 14 | 0.798 | 0.439 | 0.011 | 1.613 | 644 | 33 |
| 240 | 240 | 876 | 14 | 0.789 | 0.413 | 0.002 | 1.407 | 673 | 35 |
| 200 | 300 | 879 | 14 | 0.799 | 0.453 | 0.037 | 1.629 | 693 | 37 |
| 300 | 160 | 886 | 15 | 0.808 | 0.432 | 0.003 | 1.661 | 654 | 32 |
| 260 | 220 | 889 | 15 | 0.768 | 0.415 | 0.002 | 1.509 | 669 | 33 |
| 220 | 280 | 892 | 15 | 0.791 | 0.464 | 0.016 | 1.628 | 702 | 35 |
| 280 | 200 | 903 | 15 | 0.754 | 0.420 | 0.005 | 1.460 | 668 | 32 |
| 240 | 260 | 906 | 15 | 0.786 | 0.434 | 0.000 | 1.498 | 703 | 35 |
| 300 | 180 | 916 | 15 | 0.754 | 0.403 | 0.002 | 1.521 | 674 | 33 |
| 260 | 240 | 919 | 15 | 0.759 | 0.417 | 0.004 | 1.503 | 699 | 35 |
| 220 | 300 | 922 | 15 | 0.787 | 0.482 | 0.004 | 1.656 | 727 | 37 |
| 280 | 220 | 932 | 16 | 0.729 | 0.412 | 0.000 | 1.527 | 695 | 32 |
| 240 | 280 | 935 | 16 | 0.791 | 0.463 | 0.002 | 1.583 | 731 | 35 |
| 300 | 200 | 946 | 16 | 0.715 | 0.401 | 0.011 | 1.393 | 697 | 32 |
| 260 | 260 | 949 | 16 | 0.772 | 0.437 | 0.003 | 1.447 | 729 | 35 |
| 280 | 240 | 962 | 16 | 0.734 | 0.424 | 0.003 | 1.557 | 724 | 34 |
| 240 | 300 | 965 | 16 | 0.804 | 0.487 | 0.007 | 1.639 | 757 | 36 |
| 300 | 220 | 976 | 17 | 0.701 | 0.417 | 0.002 | 1.510 | 723 | 32 |
| 260 | 280 | 979 | 17 | 0.798 | 0.459 | 0.001 | 1.507 | 758 | 34 |
| 280 | 260 | 992 | 17 | 0.766 | 0.441 | 0.005 | 1.537 | 754 | 34 |
| 300 | 240 | 1005 | 17 | 0.724 | 0.433 | 0.001 | 1.574 | 750 | 34 |
| 260 | 300 | 1008 | 16 | 0.836 | 0.464 | 0.001 | 1.590 | 643 | 29 |
| 280 | 280 | 1022 | 17 | 0.814 | 0.442 | 0.004 | 1.472 | 651 | 28 |
| 300 | 260 | 1035 | 17 | 0.773 | 0.436 | 0.005 | 1.589 | 659 | 28 |
| 280 | 300 | 1051 | 17 | 0.864 | 0.425 | 0.002 | 1.514 | 670 | 29 |
| 300 | 280 | 1065 | 18 | 0.829 | 0.420 | 0.013 | 1.561 | 678 | 28 |
| 300 | 300 | 1095 | 18 | 0.876 | 0.405 | 0.006 | 1.493 | 696 | 28 |

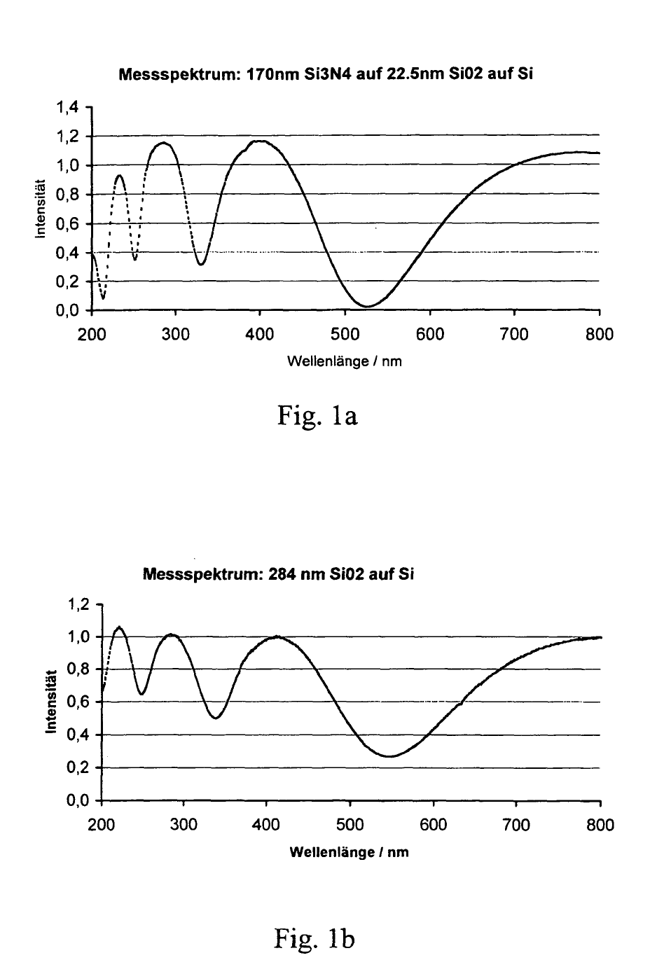

The measured spectra depicted in FIG. 1 can be acquired, for example, using an optical measurement device such as the one known from DE 100 21 379 A1 discussed above. The reader is referred to that document for complete details of the measurement procedure. According to the present invention, the characteristic curve shape parameters cited in this example are derived from the acquired measured spectrum, and the results are compared to the values in the table above. The result then obtained is one or more optical thicknesses, and thus layer Thickness combinations, for which there is a particularly good match between the curve shape parameters derived from the measured spectrum and the calculated parameters of the list. For those thickness combinations, associated analysis spectra are then calculated and are compared to an acquired measured spectrum as depicted in FIG. 1a. Since it usually cannot be assumed that the thickness combination discovered using the method according to the present invention already corresponds to the one that is present, known coarse and fine fitting procedures, such as grid, interval, and Powell methods, then advantageously follow for determination of the exact layer thicknesses. In this case the method according to the present invention serves to restrict the parameter space so that the subsequent fitting procedures reach their goal considerably faster.

It is advantageous to add further known methods as well as the method according to the present invention for restricting the parameter space, especially in order, for example, to exclude discovered layer thickness combinations (D1, D2) as implausible. The extremes method and Fourier transform method already mentioned can, in particular, be used for this purpose.

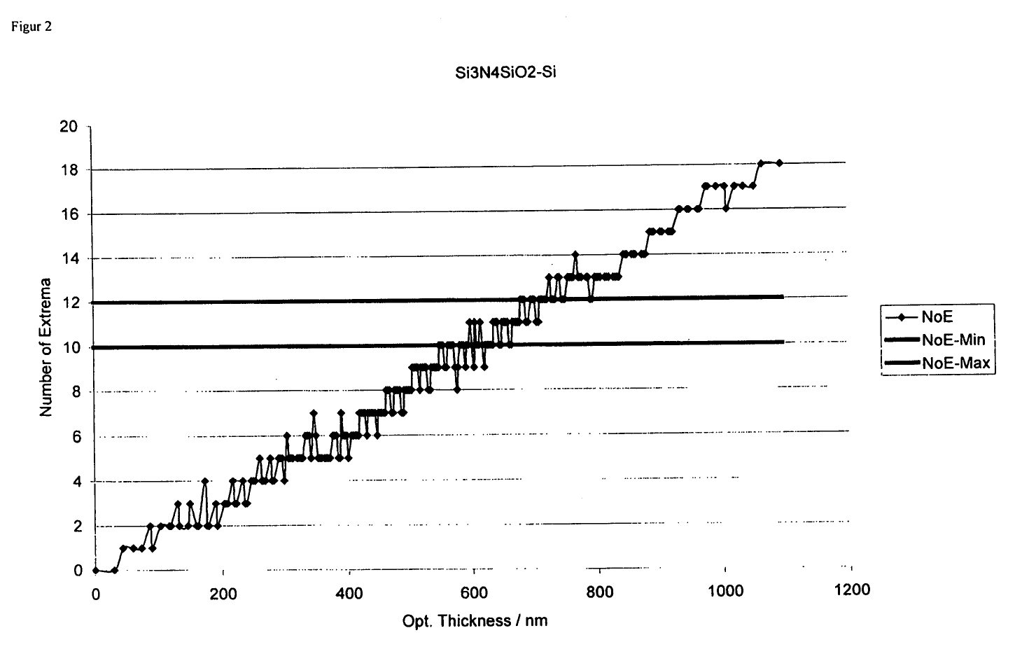

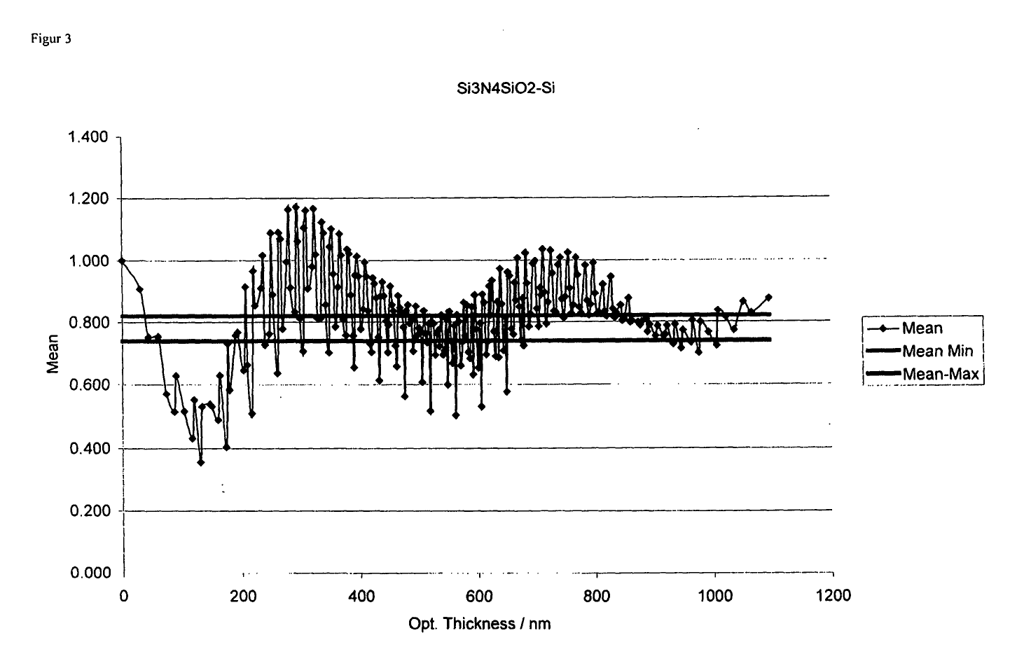

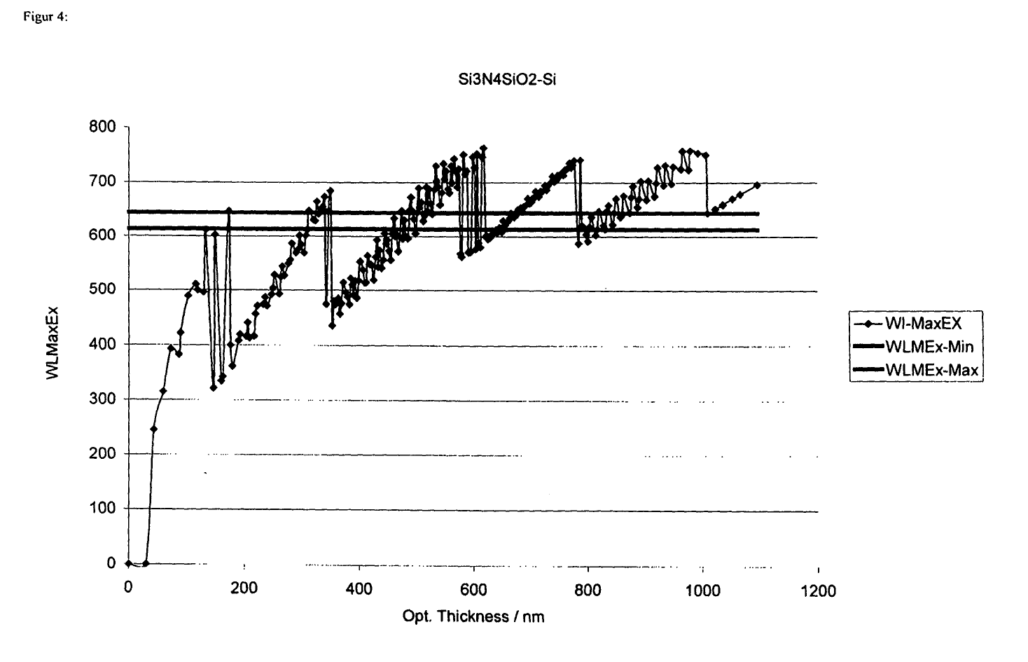

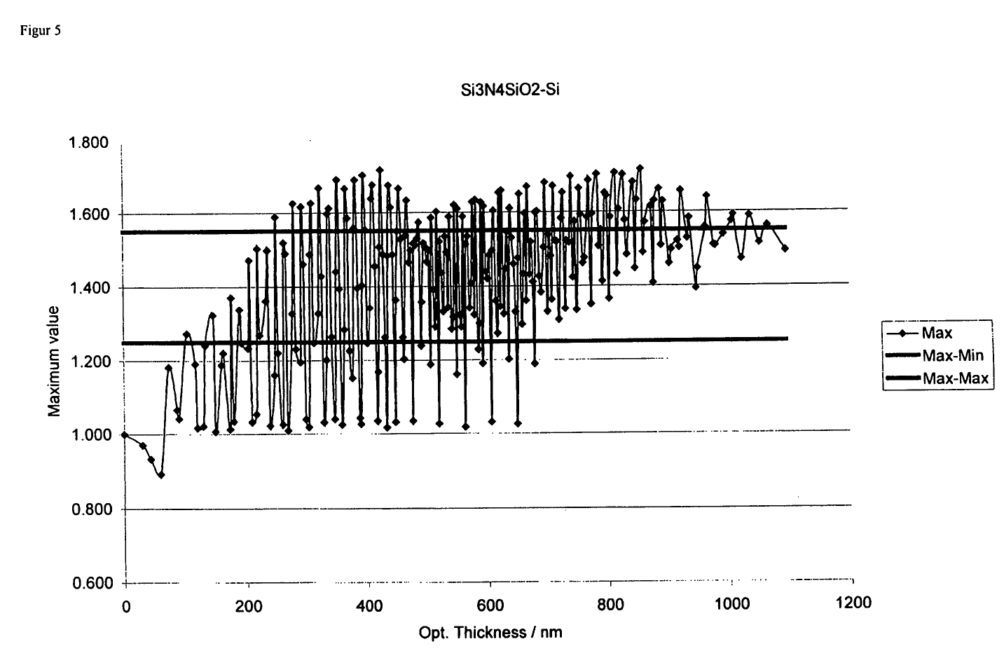

FIGS. 2 through 5 show how specified values of optical parameters (in this case, layer thickness combinations) can be associated with certain characteristic curve shape parameters of the acquired measured curve. In FIG. 2, the correlation is approximately linear, i.e. the number of extremes increases in proportion to the optical thickness. The “Mean” parameter (FIG. 3) changes with optical thickness in the form of a damped oscillation; although the fluctuation range decreases with increasing optical thickness, the mean also continuously approaches a constant. This of course also reflects the spectral resolution of the measurement apparatus, and therefore the scanning theorem. The parameter WLMaxEx plotted against optical thickness in FIG. 4 describes the location of the longest-wave maximum. These values are of course also limited by the wavelength range of the measurement apparatus (here between 200 nm and 800 nm). Curves that do not exhibit a unequivocal maximum (boundary wavelengths are excluded and extremes must exceed a predefined threshold value) have zero assigned to them as parameter value. Proceeding from an optical thickness of zero, this value rises until the extreme has, so to speak, migrated out of the measurement range. FIG. 5 shows that in the optical thickness range indicated, the Maximum (intensity) Value parameter oscillates approximately from one value to the next.

The overall conclusion is that assignment of an optical thickness by way of a single value obtained from the measured curve is ambiguous. Several such values must therefore be utilized. The fluctuation ranges in the individual curves indicate the different degrees to which the parameter value ranges need to be restricted. The possibility for restriction, and therefore for filtering, is illustrated by the horizontal lines in the Figures as an example of one possible evaluation variant.

In general: from the assigned values it is possible (even using other known methods) to select the most probable ones and to use those to calculate an analysis spectrum.

Simplified exemplary embodiment of a filter:

A spectrum (175 nm Si3N4 on 190 nm SiO2) that does not correspond to the one depicted in FIG. 1a yields the target values listed in Table 2, column 1, “Target value.”

If the filter ranges indicated in Table 2 (corresponding to the horizontal lines in FIGS. 2 through 5) are sequentially selected out of the 256 list entries originally provided in Table 1, the number of list entries is successively reduced from an initial 63 to four.

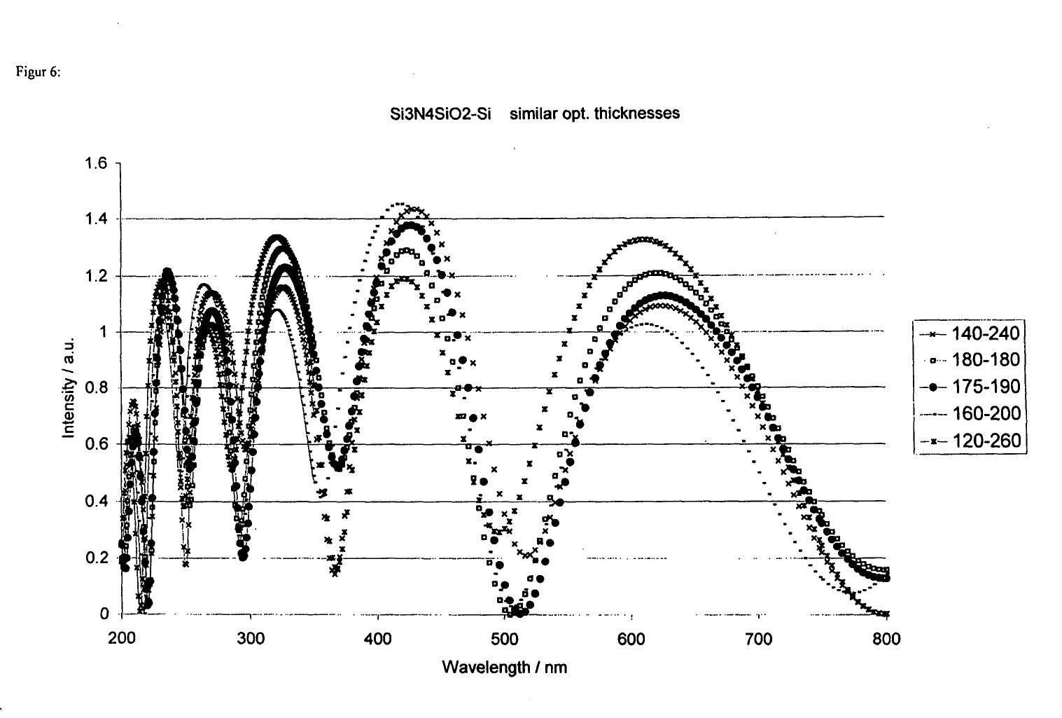

The spectra associated with these list entries are depicted in FIG. 6 together with the target spectrum (175-190).

The best match is obtained for the adjacent curves having layer thicknesses (180-180) and (160-200).

TABLE 2
Reduction using filters. Initial value = 256 list entries

| Target value | Filter step/Filter name | Filter range | No. of list entries |
|---|---|---|---|
| 11 | 1/NoE | 10-12 | 63 |
| 628 | 2/WL-Max | 613-643 | 12 |
| 1.4 | 3/Max | 1.25-1.55 | 9 |
| 0.78 | 4/Mean | 0.74-0.82 | 4 |

A coarse fit in the indicated thickness ranges (e.g. increment ±20 nm in each case) leads to a result with a good curve shape match for the table entry with thicknesses D1=D2=180 nm. A subsequent fine fit using a grid, interval, or Powell method yields a result with the desired accuracy (e.g. 0.1 nm).

For simplicity's sake, the example above is limited to determining only the layer thicknesses of a double layer. The manner in which the example can be extended to the determination of further optical parameters, such as the refractive index n or extinction coefficient k, will be evident to one skilled in the art.

In particular, it is also possible with the aforesaid method according to the present invention to preselect the relevant layer types (chemical composition), in which context a selection must be made from a correspondingly larger parameter space (parameter lists for different single- or multiple-layer compositions). An a priori limitation is, however, usually possible, since the customer (user) in most cases knows which possible combinations may occur. For example, the determination of the combination that is present (i.e. the sequence of layer compositions) can be made in the background while stage positions are being programmed in for the next measurement. Before the actual measurement of optical parameters begins, the resulting combination is then presented to the customer (user), who can accept or correct it.

What is claimed is:

1. A method for automatic determination of optical parameters of a layer stack, such as layer thicknesses, refractive indices, or absorption coefficients, comprising the steps of:
acquiring an optical spectrum at one location of the layer stack;
calculating an analysis spectrum on the basis of specified optical parameter values;
comparing the acquired optical spectrum to the analysis spectrum;
optimizing the calculated analysis spectrum to the measured spectrum,
classifying the acquired measured spectrum on the basis of curve shape parameters that characterize the measured spectrum and are determined therefrom, and
comparing those curve shape parameters to corresponding spectrum curve shape parameters calculated for known layer stacks in order to determine values or value ranges for the optical parameters to be identified, on the basis of which the analysis spectrum or spectra for comparison with the measured spectrum is/are calculated.

2. The method as defined in claim 1, wherein the acquired measured spectrum is classified on the basis of one or more of the following curve shape parameters: local noise of the spectrum; mean of the spectrum; standard deviation of the mean; number and location of the extremes; a classification of the extremes, e.g. as to spectral location; intensity values or relative spacings between them; features of enveloping curves of the minima and maxima; an averaged curve profile; beats; and parameters from the Fourier-transformed curves of the acquired measured spectrum, such as the number, location, and values of the extremes present therein.

3. The method as defined in claim 2, wherein in order to restrict the value ranges for the optical parameters to be determined, an evaluation of the acquired measured spectrum is additionally accomplished, depending on the type of layer stack, in accordance with an extremes method and/or a Fourier transform method.

4. The method as defined in claim 1, wherein the optimization of the calculated analysis spectrum to the measured spectrum is performed by means of known coarse and fine fitting methods.

5. The method as defined in claim 1, wherein the values determined for optimization of the calculated analysis spectrum are optionally corrected for the optical parameters to be determined.

6. A method for automatic determination of the composition sequence of a layer stack, comprising the steps of:
acquiring an optical measured spectrum from a location in the layer stack,
classifying the measured spectrum on the basis of curve shape parameters that characterize the measured spectrum and are determined therefrom, and
identifying one or more possible composition sequences of the layer stack by comparison to corresponding curve shape parameters of classified spectra belonging to known layer stacks.

7. The method as defined in claim 6, wherein simultaneously with the identification of the composition of the layer stack from the comparison to curve shape parameters of the classified spectra, value ranges are determined for the further optical parameters to be identified.

8. The method as defined in claim 6, wherein on the basis of the identified composition sequence of the layer stack as well as any further optical parameter values, analysis spectra are calculated and are optimized to the acquired spectra.

9. The method as defined in claim 6, wherein the identified composition sequence of the layer stack, as well as any further identified optical parameters, are subjected to an inspection before the automatic determination of optical parameters of the layer stack by comparing those curve shape parameters to corresponding spectrum curve shape parameters calculated for known layer stacks, on the basis of the determined optical parameter the analysis spectrum or spectra for comparison with the measured spectrum is/are calculated.

10. A computer program having program code means, the computer program carries out the steps:
acquiring an optical spectrum at one location of the layer stack;
calculating an analysis spectrum on the basis of specified optical parameter values;
comparing the acquired optical spectrum to the analysis spectrum;
optimizing the calculated analysis spectrum to the measured spectrum,
classifying the acquired measured spectrum on the basis of curve shape parameters that characterize the measured spectrum and are determined therefrom, and
comparing those curve shape parameters to corresponding spectrum curve shape parameters calculated for known layer stacks in order to determine values or value ranges for the optical parameters to be identified, on the basis of which the analysis spectrum or spectra for comparison with the measured spectrum is/are calculated,
when the computer program is executed on a computer or a corresponding computation unit.

11. The computer program as defined in claim 10, wherein the acquired measured spectrum is classified on the basis of one or more of the following curve shape parameters: local noise of the spectrum; mean of the spectrum; standard deviation of the mean; number and location of the extremes; a classification of the extremes, e.g. as to spectral location; intensity values or relative spacings between them; features of enveloping curves of the minima and maxima; an averaged curve profile; beats; and parameters from the Fourier-transformed curves of the acquired measured spectrum, such as the number, location, and values of the extremes present therein.

12. The computer program as defined in claim 11, wherein in order to restrict the value ranges for the optical parameters to be determined, an evaluation of the acquired measured spectrum is additionally accomplished, depending on the type of layer stack, in accordance with an extremes method and/or a Fourier transform method.

13. The computer program as defined in claim 10, wherein the optimization of the calculated analysis spectrum to the measured spectrum is performed by means of known coarse and fine fitting methods.

14. The computer program as defined in claim 10, wherein the values determined for optimization of the calculated analysis spectrum are optionally corrected for the optical parameters to be determined.

15. The computer program as defined in claim 10, wherein a program code means is stored on a computer-readable data medium, for carrying out the method when the computer program is executed on a computer or a corresponding computation unit.
